(19) United States
(12) Patent Application Publication
(10) Pub. No.: US 2026/0238451 A1
(43) Pub. Date: Aug. 13, 2026

(54) TCI-State Selection for Individual Channel/Signals for Unified TCI-State Framework With Multi-TRP in Wireless Communication

(71) Applicant: Apple Inc., Cupertino, CA (US)

(72) Inventors: Hong HE, San Jose, CA (US); Chunhai YAO, Beijing (CN); Chunxuan YE, San Diego, CA (US); Dawei ZHANG, Saratoga, CA (US); Jie CUI, San Jose, CA (US); Wei ZENG, Saratoga, CA (US)

(21) Appl. No.: 19/471,880

(22) PCT Filed: Apr. 5, 2023
(86) PCT No.: PCT/CN2023/086348

§ 371 Date: Oct. 2, 2025

(51) Int. Cl. H04L 5/00; H04W 72/23

(52) U.S. Cl. CPC H04L 5/0094; H04W 72/23

(57) ABSTRACT

A user equipment (UE) configured to establish a connection to a base station in multi-transmission reception point (mTRP) mode, wherein the UE is configured to apply a first set of transmission configuration indicator (TCI) states to communicate with the base station via one or multiple TRPs, the UE is further configured that a TCI selection field is not present in a TCI state update command, receive the TCI state update command indicating a TCI codepoint mapping to one or more downlink (DL) TCI states in a second set of TCI states and apply the one or more TCI states of the second set for physical downlink shared channel (PDSCH) receptions from one or multiple TRPs that is scheduled by the Downlink Control Information (DCI) that includes TCI state update command.

### TECHNICAL FIELD

The present disclosure generally relates to wireless communication, and in particular, to TCI-state selection for individual channel/signals for unified TCI-state framework with multi-TRP in wireless communication.

### BACKGROUND

A user equipment (UE) may connect to a network via a base station that controls multiple transmission and reception points (TRPs). In some scenarios, the UE may operate in multi-TRP (mTRP) mode where the UE establishes and maintains a connection with multiple TRPs simultaneously. There exists a need for techniques to handle various issues regarding transmission configuration indicator (TCI) state mapping to individual downlink (DL) and (UL) channels/signals.

### SUMMARY

Some exemplary embodiments are related to a method performed by a user equipment (UE). The method includes establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, the UE is further configured that a TCI selection field is present in a TCI state update command, receiving the TCI state update command indicating the TCI selection field and based on the TCI selection field, applying the first joint or DL TCI state for physical downlink shared channel (PDSCH) receptions from a first or second TRP and applying the second joint or DL TCI state for PDSCH receptions from the other of the first or second TRP that is scheduled by the Downlink Control Information (DCI) that includes TCI state update command.

Other exemplary embodiments are related to a method performed by a user equipment (UE). The method includes establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, receiving a downlink control information (DCI) 1_0 or 0_0 scheduling a physical downlink shared channel (PDSCH) or a physical uplink shared channel (PUSCH), determining one or more TCI states of the first set of TCI states to apply for the PDSCH or the PUSCH scheduled by the DCI 1_0 or 0_0 and applying the one or more TCI states of the first set based on the determining.

Still further exemplary embodiments are related to a method performed by a user equipment (UE). The method includes establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, the UE is further configured that a TCI selection field is present in a TCI state update command, receiving the TCI state update command indicating the TCI selection field and based on the TCI selection field, applying the first joint or DL TCI state for physical downlink shared channel (PDSCH) receptions from a first or second TRP and applying the second joint or DL TCI state for PDSCH receptions from the other of the first or second TRP that is scheduled by the Downlink Control Information (DCI) that includes TCI state update command.

Additional exemplary embodiments are related to a method performed by a user equipment (UE). The method includes establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, receiving a configuration for aperiodic channel state information (CSI) reference signal (CSI-RS) resources for a first TRP and a second TRP and determining whether to apply the first joint or DL TCI state, the second joint or DL TCI state, or both the first and second joint or DL TCI state to the CSI-RS resources.

Further exemplary embodiments are related to a method performed by a user equipment (UE). The method includes establishing a connection to a base station in multi-transmission reception point (mTRP) mode, wherein the UE is configured to apply a first set of transmission configuration indicator (TCI) states including a first joint or UL TCI state to communicate with the base station via one or multiple TRPs, receiving a sounding reference signal (SRS) resource set by applying the first joint or UL TCI state, receiving a TCI state update command indicating a second joint or UL TCI state for receiving a physical uplink shared channel (PUSCH) associated with the SRS resource set and deferring applying the second joint or UL TCI state until a next occasion of the SRS resource set after the PUSCH.

Other exemplary embodiments are related to a method performed by a user equipment (UE). The method includes establishing a connection to a base station in multi-downlink control information (mDCI) based multi-transmission reception point (mTRP) mode, wherein the UE is configured with a physical uplink control channel (PUCCH) transmission carrying HARQ-ACK information, an aperiodic channel state information reference signal (CSI-RS) resource set, or a sounding reference signal (SRS) resource set for physical uplink shared channel (PUSCH) transmissions, receiving a DCI in a first control resource set (CORESET) triggering one of the two SRS resource sets and determining a first transmission configuration indication (TCI) state to apply for the configured PUCCH transmission, aperiodic CSI-RS resource set, or SRS resource set based on a first CORESET pool index for the first CORESET.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4a shows a full set TCI state combination for separate TCI state mode according to various exemplary embodiments.

FIG. 4b shows the existing TCI state activation/deactivation MAC-CE according to current specification.

FIG. 5a shows a diagram for indicating whether to update a first DL TCI-state for PDSCH reception, a second DL TCI state for PDSCH reception or both DL TCI states for PDSCH reception using a TCI selection field in a scheduling DCI according to various exemplary embodiments.

FIG. 5b shows a diagram for the indicating whether to update a first TCI-state for PDSCH reception, a second TCI state for PDSCH reception or both TCI states for PDSCH reception when a TCI selection field is not configured in a scheduling DCI according to various exemplary embodiments.

FIG. 6 shows a diagram for interpreting the codepoint of the TCI selection field in a scheduling DCI for PDSCH in multi-TRP operation.

FIG. 7a shows a diagram for applying TCI states to CSI-RS resource sets in a group-based beam reporting configuration according to various exemplary embodiments.

FIG. 7b shows a diagram for applying TCI states to CSI-RS resource sets in a non-coherent joint transmission (NCJT) configuration according to various exemplary embodiments.

FIG. 8 shows a diagram for deferring the application of a new TCI state for a PUSCH reception until a next SRS occasion when the SRS associated with the PUSCH reception was received with a current TCI state according to various exemplary embodiments.

FIG. 9 shows diagrams demonstrating a dynamic TCI-state selection for a given PUCCH resource according to various exemplary embodiments.

### DETAILED DESCRIPTION

The exemplary embodiments may be further understood with reference to the following description and the related appended drawings, wherein like elements are provided with the same reference numerals. The exemplary embodiments relate to beam management and multi-transmission reception point (TRP) operation.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The exemplary embodiments are described with regard to multi-TRP (mTRP) operation. From the perspective of the UE, mTRP operation may include establishing and maintaining a connection with multiple TRPs at the same time, including respective downlink (DL) and uplink (UL) channels and/or signals. For example, different channel state information (CSI)-reference signals (RS) resource sets may be configured for different TRPs to support CSI measurement.

In 5G NR, a unified transmission configuration indicator (TCI) framework is intended to facilitate streamlined mTRP operation. In the unified TCI framework, the base station can configure the UE with a joint TCI state pool or a separate TCI state pool via radio resource control (RRC) signaling. In joint TCI mode, the TCI state pool can include common TCI states that can be applied for multiple DL channels, multiple UL channels, or both DL and UL channels. The joint TCI state pool can include DL TCI states, UL TCI states, and joint TCI states (DL and UL). In separate TCI mode, a DL TCI state pool and a UL TCI state pool are separately configured. In some cases, a common beam can be associated with multiple channels or signals. Thus, the base station can configure a DL TCI state to be commonly applied for multiple DL channels or signals, e.g., PDSCH, CSI-RS, CORESET, etc.; a UL TCI state to be commonly applied for multiple UL channels or signals, e.g., PUSCH, SRS, PUCCH, etc.; or a joint TCI state to be commonly applied for multiple DL/UL signals.

In some cases, up to four current valid TCI states can be applied by the UE simultaneously in a TCI state combination per component carrier (CC) or bandwidth part (BWP) or per set of CCs/BWPs. Up to 16 TCI states can be activated for a UE at one time, and a TCI state codepoint can be associated with a single TCI state (N=1) from the activated TCI states or multiple TCI states (N=2; N=3; or N=4) from the activated TCI states. The network can transmit a unified TCI state activation/deactivation MAC CE to activate/deactivate up to 16 TCI states and associate the activated states to one or more TCI codepoints, in particular, up to 8 TCI codepoints. A three-bit TCI state field can be dynamically indicated in a downlink control information (DCI) format 1_1 and 1_2 (with or without DL assignment). The TCI codepoint indicated in the TCI state field maps to one or more of the activated TCI states. A given TCI state can be associated with one or more of the TCI codepoints in various combinations with other TCI states up to a maximum of 4 TCI states when the TCI states are configured separately (and up to a maximum of 2 TCI states when the TCI states are configured jointly). In separate TCI state mode, the up to 4 TCI states can be separated into pairs, wherein a first pair is applied for a first TRP and a second pair is applied for a second TRP.

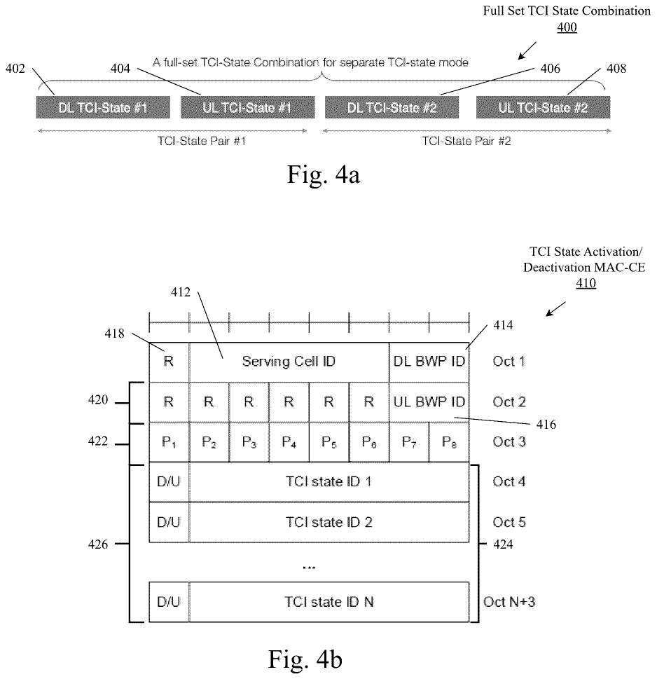

FIG. 4a shows a full set TCI state combination 400 for separate TCI state mode according to various exemplary embodiments. As described above, two DL TCI states and two UL TCI states are indicated in the full set. The DL TCI state with a lower octet index than the other DL TCI state is determined as the first DL TCI state 402 (DL TCI state 1), and the other DL TCI state is determined as the second DL TCI state 406 (DL TCI state 2). The UL TCI state with a lower octet index than the other UL TCI state is determined as the first UL TCI state 404 (UL TCI state 1), and the other UL TCI state is determined as the second UL TCI state 408 (UL TCI state 2). The first DL TCI state 402 and the first UL TCI state 404 comprise the first TCI state pair, e.g., for the first TRP, and the second DL TCI state 406 and the second UL TCI state 408 comprise the second TCI state pair, e.g., for the second TRP.

According to various aspects of these exemplary embodiments, operations are described for solving various open issues in the unified TCI state framework. While the exemplary embodiments provide benefits to the 5G NR unified TCI framework, the exemplary embodiments are not limited to the 5G NR unified TCI framework or even a 5G system. The exemplary embodiments may be applied to any appropriate type of wireless communication system. The exemplary embodiments introduced herein may be used independently from one another, in conjunction with other currently implemented mechanisms for mTRP operation, in conjunction with future implementations of mechanisms for mTRP operation or independent from other mechanisms for mTRP operation.

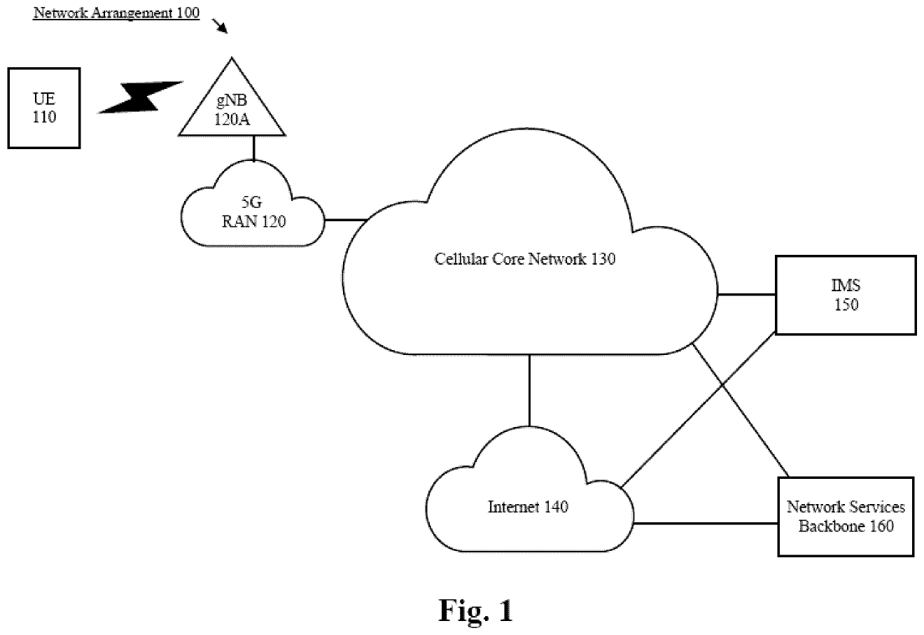

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes.

Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

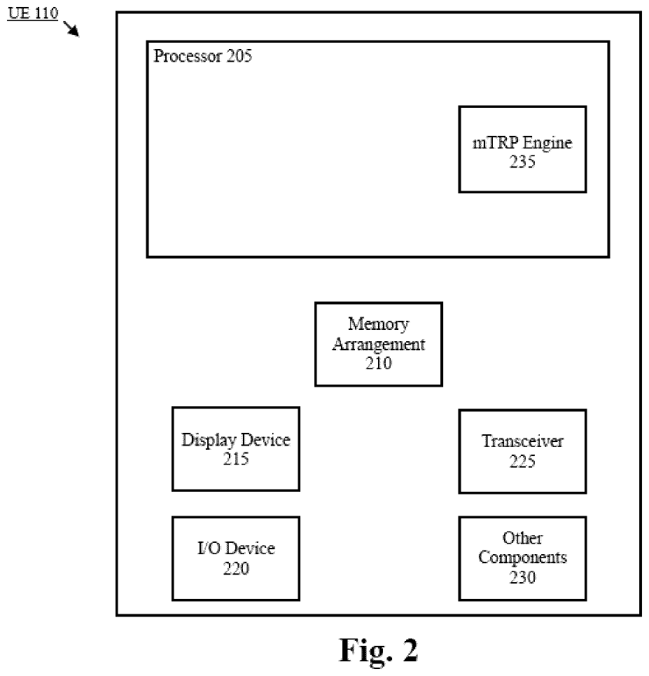

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP engine 235. The mTRP engine 235 may perform various operations related to mTRP operation. To provide some general examples, the mTRP engine 235 may perform operations such as, but not limited to, receiving a TCI state update, determining which one or more TCI states are to be updated and using the updated TCI states for downlink and/or uplink communication.

The above referenced engine 235 being an application (e. g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

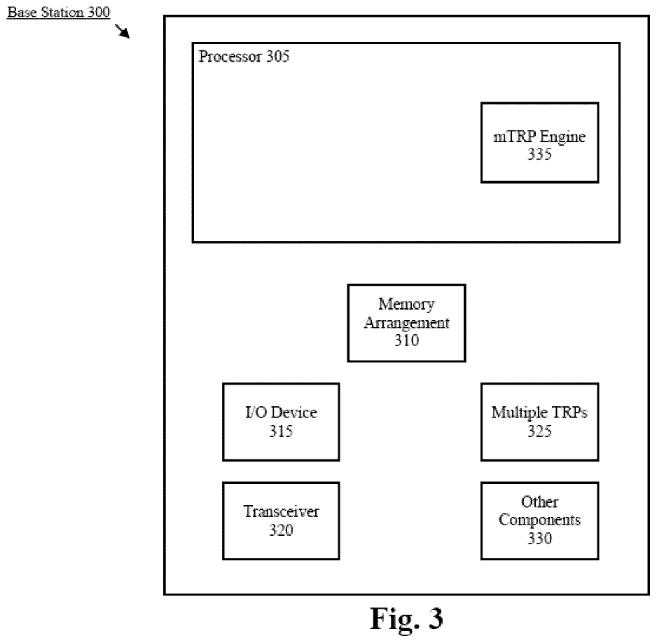

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUS, transceiver chains, antenna elements, antenna panels, etc.

As indicated above, in some scenarios, the multiple TRPs 325 may be deployed locally at the base station 300. In other scenarios, one or more of the multiple TRPs 325 may be deployed at physical locations remote from the base station 300 and connected to the base station via a backhaul connection. The base station 300 may be configured to control the multiple TRPs 325 and perform operations such as, but not limited to, assigning resources, configuring reference signals, implementing beam management techniques, etc.

The processor 305 may be configured to execute a plurality of engines for the base station 300. For example, the engines may include a mTRP engine 335. The mTRP engine 335 may perform various operations related to mTRP operation. To provide some general examples, the mTRP engine 335 may perform operations such as, but not limited to, transmitting a TCI update to the UE 110 and communicating with the UE 110 using the updated TCI states.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

As mentioned above, the exemplary embodiments relate to a unified TCI framework that is configured to facilitate mTRP operation. Those skilled in the art will understand that a TCI state may indicate that a beam is quasi co-located to specific reference signal and define a search space. Thus, the TCI state may indicate the location of one or more search spaces relative to one or more reference signals. During operation, the UE 110 may be configured with multiple TCI states and the network may indicate which of the TCI states are to be used for subsequent communication.

In 5G NR, a unified TCI state may be used for multiple channels simultaneously. The network may configure a common TCI pool and then indicate one or more TCI states from the common TCI pool to be used for subsequent communication. For example, a unified TCI state may be commonly applied to downlink signals, e.g., reference signals, a CORESET, physical downlink shared channel (PDSCH), etc. In another example, a unified TCI state may be commonly applied to uplink signals, e.g., physical uplink shared channel (PUSCH), physical uplink control channel (PUCCH), sounding reference signals (SRS), etc. In another example, a unified TCI state may be commonly applied for multiple UL and DL channels. In this example, there may be a joint TCI state pool for the UL/DL or there may be a separate downlink TCI state pool and UL TCI state pool. The exemplary embodiments may be applied to both the joint TCI state pool mechanisms and the separate UL/DL TCI state pool mechanism.

Some exemplary embodiments are described with regard to a TCI codepoint. Those skilled in the art will understand that the term “TCI codepoint” refers to a value that may be included in a TCI field of DCI. Each TCI codepoint may be associated with one or more TCI states based on a unified TCI state activation/deactivation MAC CE. For instance, the MAC CE may be used to map different combinations of one or more TCI states to the TCI field in the DCI. The network can transmit a unified TCI state activation/deactivation MAC CE to activate/deactivate up to 16 TCI states and associate the activated states to one or more TCI codepoints, in particular, up to 8 TCI codepoints. The unified TCI state activation/deactivation MAC CE is specified in 3GPP TS 38.321.

FIG. 4b shows the existing TCI state activation/deactivation MAC-CE 410 according to current specification. The MAC-CE 410 comprises a field 412 for indicating a serving cell ID for which the MAC CE 410 applies, a field 414 for a DL BWP ID for which the MAC CE 410 applies and a field 416 for a UL BWP ID for which the MAC CE 410 applies, as specified in Rel-17. The MAC-CE 410 further includes a field 418 for a reserved (R) bit in the first octet and six R bits 420 in the second octet.

A third octet comprises eight 1-bit Pᵢ fields 422 for indicating whether each TCI codepoint i=1, . . . , 8, has multiple TCI states or a single TCI state associated therewith. For example, if the Pᵢ field 422 is set to 1, it indicates that the i-th TCI codepoint includes a DL TCI state and a UL TCI state. If the Pᵢ field 422 is set to 0, it indicates that the i-th TCI codepoint includes only: a DL TCI state or joint TCI state; or a UL TCI state. The codepoint to which a TCI state is mapped is determined by its ordinal position among all the TCI state ID fields.

The following octets of the MAC CE 410 can indicate one or more TCI state IDs (maximum of 16) to be activated. Each TCI state ID field 424 has an associated D/U field 426 indicating whether the TCI state ID in the same octet is for joint/downlink or o uplink TCI state. If this field is set to 1, the TCI state ID in the same octet is for joint/downlink. If this field is set to 0, the TCI state ID in the same octet is for uplink.

A TCI update can be indicated in a DCI. The DCI can carry the DL BWP and the UL BWP for which the TCI update applies and a TCI state field comprising 3 bits carrying a TCI codepoint mapping to one or more of the activated TCI states based on the most recently received activation/deactivation MAC CE, as described above. The TCI codepoint can map to a full set of TCI states (e.g., two joint TCI states or four separate TCI states) or a sub-set of TCI states (e.g., one joint TCI state or one, two or three separate TCI states). The full set of TCI states in separate TCI mode was described above in FIG. 4a. As described above, the full set of TCI states can be grouped into a first pair for the first TRP and a second pair for the second TRP.

Various issues have been identified regarding the mapping of TCI states to individual DL/UL channels/signals. The present embodiments provide solutions to these issues.

With regard to a first issue, it was agreed that a ‘TCI-selection’ field can be included in DCI formats 1_1 and 1_2. It was further agreed that the TCI selection field can be configured by the network via RRC signaling to be present in the DCI or not present in the DCI. It remains open regarding how to determine the TCI-state for PDSCH scheduled/activated by DCI format 1_1/1_2 when the ‘TCI-selection’ field is not present in DCI.

According to one aspect of the present disclosure, various approaches may be considered to indicate the TCI state for PDSCH reception for single DCI (sDCI)-based mTRP in view of whether the TCI selection field is configured to be present or not.

In one case, the TCI-selection field is configured by RRC to be present in a scheduling DCI. When the TCI-selection field is present in the scheduling DCI, different codepoints of the 2-bit TCI-selection field can be used to indicate ‘the first’, ‘the second’, ‘both’ of the two indicated TCI states for PDSCH reception. For example, the codepoint 00 can map to the first DL TCI state; the codepoint 01 can map to the second DL TCI state; and the codepoint 11 can map to both the first and second DL TCI states. The codepoint 10 can be reserved. The first DL TCI state can apply for DL communications with the first TRP and the second DL TCI state can apply for DL communications with the second TRP in a multi-TRP configuration.

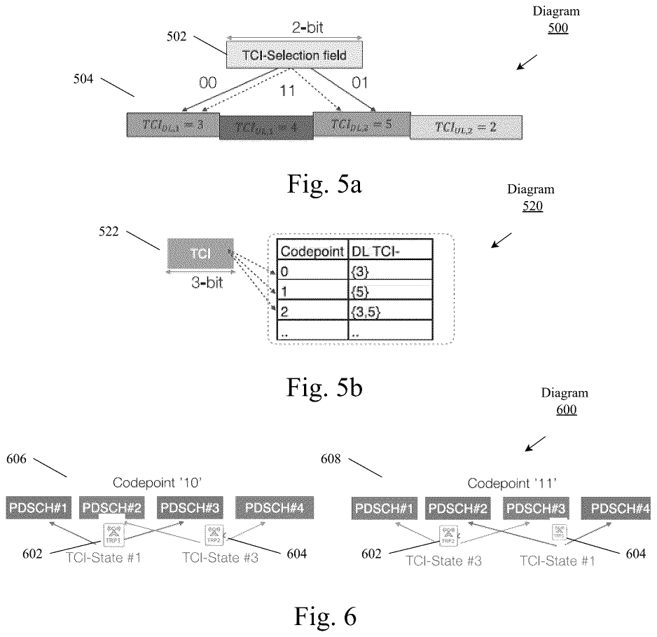

FIG. 5a shows a diagram 500 for indicating whether to update a first DL TCI-state for PDSCH reception, a second DL TCI state for PDSCH reception or both DL TCI states for PDSCH reception using a TCI selection field 502 in a scheduling DCI according to various exemplary embodiments. In this example, the scheduling DCI can indicate a TCI field codepoint that maps to a unified TCI state combination 504 of {3, 4, 5, 2}. The first TCI pair comprises {3.4} and the second TCI pair comprises {5,2}. When the TCI-selection field is included in the DCI, the codepoint 00 can indicate the DL TCI state {3} in the first TCI pair {3,4} is to be applied for PDSCH reception for the first TRP. The codepoint 01 can indicate the DL TCI state {5} in the second TCI pair {5,2} is to be applied for PDSCH reception for the second TRP. The codepoint 11 can indicate the DL TCI states for both pairs (both TRPs) are to be applied.

In another case, if the TCI-selection field is configured by RRC to be not present in the scheduling DCI, the UE can determine which DL TCI states to update based on the TCI state codepoint indicated in the most recent scheduling DCI. The codepoint of the 3-bit TCI field in the most recent scheduling DCI is used to directly map the corresponding TCI-states for PDSCH reception based on the TCI-state activation/deactivation MAC-CE. The network can properly set the codepoint of the TCI field to map to the DL TCI states for PDSCH selection.

FIG. 5b shows a diagram 520 for the indicating whether to update a first TCI-state for PDSCH reception, a second TCI state for PDSCH reception or both TCI states for PDSCH reception when a TCI selection field is not configured in a scheduling DCI according to various exemplary embodiments. In this example, the scheduling DCI can indicate a TCI field codepoint 522 (3 bits) that maps to a DL TCI state or DL TCI state combination.

In this example, the TCI field codepoint 00 can indicate the DL TCI state {3} is to be applied for PDSCH reception for the first TRP. The codepoint 01 can indicate the DL TCI state {5} is to be applied for PDSCH reception for the second TRP. The codepoint 2 can indicate the DL TCI states {3,5} are to be applied for PDSCH reception for both TRPs.

According to another aspect of these exemplary embodiments, different approaches may be considered to select the TCI-state(s) for PDSCH/PUSCH scheduled by a fallback DCI (i.e., DCI format 1_0 or 0_0) ) in sDCI-based mTRP scenarios.

The TCI field and TCI-selection field discussed above is not specified for use in the fallback DCI. In these embodiments, it is assumed that two joint TCI states or two DL TCI states were previously indicated. In these embodiments the UE can determine which one or both of the first or second joint/DL TCI states should be applied when a PDSCH/PUSCH is scheduled by a fallback DCI.

In a first option, the network can explicitly configure via RRC signaling which one of the first, the second, or both of the indicated joint/DL TCI states should be applied when PDSCH/PUSCH is scheduled by a fallback DCI.

In a second option, different fixed rules may be hard-encoded in specification to select the TCI-state(s) for PDSCH/PUSCH scheduled by a fallback DCI for different mTRP modes. One fixed rule can specify that the UE shall apply both the first and second joint/DL TCI states for PDSCH reception when certain mTRP modes are configured for the UE. For example, when a single frequency network (SFN) scheme is configured for PDSCH via the IE ‘sfnSchemePdsch’, the UE shall apply both TCI states for PDSCH reception. In another example, when a coherent joint transmission (CJT) scheme is configured for PDSCH (CJT-PDSCH), and the UE supports two TCI states for CJT-PDSCH, the UE shall apply both TCI states for PDSCH reception. Another fixed rule can specify whether the UE shall apply the first or the second joint/DL TCI states for PDSCH and PUSCH when certain mTRP modes are configured for the UE. For example, when a CJT-PDSCH scheme is configured, and the UE supports one TCI state for CJT-PDSCH, the UE shall apply one of the two TCI states for PDSCH/PUSCH scheduled by fallback DCI.

With regard to a second issue, it was agreed that, for unified TCI-state extension to sDCI-based mTRP, the detailed definitions of the ‘TCI-selection’ field in scheduling DCI for codepoint ‘00’ and ‘01’ indicate ‘the first’ or ‘the second’ of two TCI-states, respectively. Whether and how to use the codepoint “11” and ‘01’ of the ‘TCI-selection’ field remains open.

According to another aspect of these exemplary embodiments, the codepoint of the TCI selection field may be defined as follows. For codepoint ‘10’, the UE can apply both of the first and the second TCI-state to the PDSCH receptions following the Rel-16 rules. For example, in mTRP operation, the first TCI state can be applied to PDSCH receptions from the first TRP and the second TCI state can be applied to PDSCH receptions from the second TRP. For Codepoint ‘11’, the UE can swap the order of ‘the first, the second’ TCI-state (i.e., ‘the second, the first’) and apply both of them to the PDSCH receptions. For example, in mTRP operation, the first TCI state can be applied to PDSCH receptions from the second TRP and the second TCI state can be applied to PDSCH receptions from the first TRP.

FIG. 6 shows a diagram 600 for interpreting the codepoint of the TCI selection field in a scheduling DCI for PDSCH in multi-TRP operation. The scheduling DCI can schedule a first PDSCH for a first TRP 602, a second PDSCH for a second TRP 604, a third PDSCH for the first TRP 602, and a fourth PDSCH for the second TRP 604. It is assumed that the TCI state combination indicated by the scheduling DCI comprises DL TCI state 1 and DL TCI state 3, e.g., {1,3}. According to the codepoint of the TCI field, it can be determined whether the DL TCI state 1 applies to the PDSCH for the first TRP and the TCI state 3 applies to the PDSCH for the second TRP, or whether these TCI states are reversed.

In 606, the codepoint of the TCI selection field indicates ‘10’. Thus, for the first PDSCH and the third PDSCH for the first TRP 602, the first TCI state 1 is applied. For the second PDSCH and the fourth PDSCH for the second TRP 604, the second TCI state 3 is applied.

In 608, the codepoint of the TCI selection field indicates ‘11’. Thus, the application of the TCI states is reversed. For the first PDSCH and the third PDSCH for the first TRP 602, the second TCI state 3 is applied. For the second PDSCH and the fourth PDSCH for the second TRP 604, the first TCI state 1 is applied.

With regard to a third issue, in the Rel-17 unified TCI-framework, aperiodic CSI-RS resource set used for Beam Management (BM) and CSI feedback can be configured to ‘follow unified TCI-state’. In Rel-18 unified TCI state extension, two DL TCI-states may be indicated for two TRPs. It remains open regarding how to select the DL TCI state for AP-CSI-RS for BM/CSI.

According to another aspect of these exemplary embodiments, for sDCI-based mTRP, the TCI state can be determined for aperiodic CSI-RS resources associated with an aperiodic CSI reporting for BM and CSI reporting that is triggered by ‘CSI request’ in DCI. In some embodiments, a fixed rule may be hard-encoded in specification to determine the TCI-state of AP NZP-CSI-RS resources. In other embodiments, an RRC parameter may be introduced in CSI-AssociatedReportConfigInfo to indicate which TCI state is applied for a CSI-RS resource set.

A fixed rule may be hard-encoded in specification to determine the TCI-state of aperiodic NZP-CSI-RS resources for the following cases. In a first case, if the CSI-report is configured with group-based beam reporting, the first TCI-state is applied for a CSI-RS resource set #1 configured by ‘resourcesForChannel’ and the second TCI-state is applied for a CSI-RS resource set #2 configured by ‘resourcesForChannel2’.

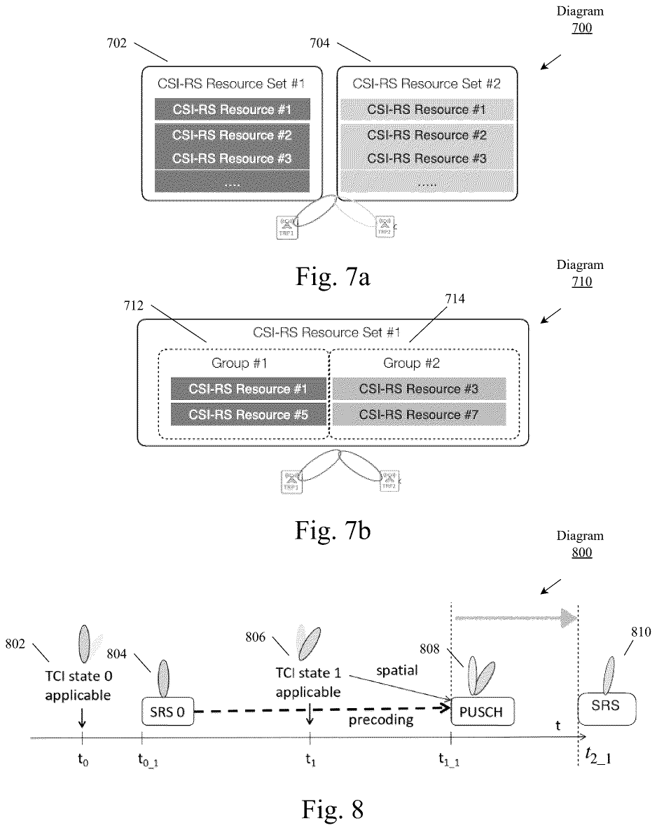

FIG. 7a shows a diagram 700 for applying TCI states to CSI-RS resource sets in a group-based beam reporting configuration according to various exemplary embodiments. The diagram 700 includes a first CSI-RS resource set 702 configured by ‘resourcesForChannel’ and a second CSI-RS resource set 704 configured by ‘resourcesForChannel2’, each including a number of CSI-RS resources. A first DL TCI state and a second DL TCI state are indicated. According to this example, a fixed rule is hard-encoded in specification so that the first DL TCI state is applied to the first CSI-RS resource set 702 and the second DL TCI state is applied to the second CSI-RS resource set 704.

In a second case, for a pair of CSI-RS resources configured by ‘cmrGroupingAndPairing’ IE in a single CSI-RS Resource Set for Non-Coherent Joint Transmission (NCJT) operation, the first TCI-state is applied for the NZP-CSI-RS resources configured by ‘pair1OfNZP-CSI-RS’ in Group #1 and the second TCI-State is applied the NZP-CSI-RS resources in Group #2 configured by ‘pair2OfNZP-CSI-RS’.

FIG. 7b shows a diagram 710 for applying TCI states to CSI-RS resource sets in a non-coherent joint transmission (NCJT) configuration according to various exemplary embodiments. The diagram 710 includes a first group of CSI-RS resources 712 configured by ‘pair1OfNZP-CSI-RS’ and a second CSI-RS resource set 714 configured by ‘pair2OfNZP-CSI-RS’, each including two NZP-CSI-RS resources. A first DL TCI state and a second DL TCI state are indicated. According to this example, a fixed rule is hard-encoded in specification so that the first DL TCI state is applied to the first group of CSI-RS resources 712 and the second DL TCI state is applied to the second group of CSI-RS resources 714.

In other cases, for other aperiodic NZP-CSI-RS, an RRC parameter may be introduced in CSI-AssociatedReportConfigInfo to indicate which TCI-state (i.e., the first or the second) is applied for a CSI-RS resource set.

With regard to a fourth issue, in current specification, the PUSCH shall use the same antenna ports as the SRS resource indicated in the scheduling DCI. On other hand, TCI-state of SRS resources for CB-PUSCH and TCI-states for CB-PUSCH may be different depending on the TCI-state update time instance. If different TCI states are applied on PUSCH and the indicated SRS resource, it is technically impossible to maintain the same antenna ports on PUSCH and SRS.

According to another aspect of these exemplary embodiments, a variety of approaches may be considered to align the TCI-state used by the most recent SRS transmission and the associated PUSCH transmission when the spatial Tx filter(s) determined from the indicated joint/UL TCI state(s) applied to a PUSCH transmission is not aligned with the spatial Tx filter(s) used for the SRS transmission corresponding to the SRS resource(s) indicated to the PUSCH transmission. These embodiments may apply for contention based (CB) or non-contention based (NCB) SRS resource sets and associated PUSCH transmissions.

In one option, when the TCI state is mismatched for PUSCH transmission, the UE shall defer applying the new TCI state until the next occasion of the same SRS resource set.

FIG. 8 shows a diagram 800 for deferring the application of a new TCI state for a PUSCH reception until a next SRS occasion when the SRS associated with the PUSCH reception was received with a current TCI state according to various exemplary embodiments. In the diagram 800, a TCI state 0 is indicated 802 at time to and applied for UL channels. At time t0_1, the TCI state 0 is applied for a first reception 804 of a first SRS resource set #0. At time t1, the TCI state 1 is indicated 806 to update the TCI state for the UL channels. The TCI state 1 indication 806 is received prior to receiving the PUSCH 808 associated with the first reception 804 of the first SRS resource set #0.

The PUSCH 808 is received at time t1_1. In accordance with the first option, the TCI state 0 is applied for the PUSCH 808 and the application of TCI state 1 is deferred until the next SRS occasion 810 at time t2_1. Accordingly, the mismatch problem is solved.

In a second option, the UE does not expect the TCI state mismatch between the SRS resource set and the associated PUSCH transmission. In this option, a restriction is placed on the network regarding the time instance where a TCI state can be updated.

In a third option, the UE expects that a single layer PUSCH transmission can be scheduled for PUSCH when the TCI states of SRS and its associated PUSCH are different.

With regard to a fifth issue, for mDCI-based mTRP, it remains open how to determine the TCI-state for PUCCH/AP-CSI-RS/SRS.

According to another aspect of these exemplary embodiments, for mDCI-based mTRP with unified TCI framework, the UE shall apply the indicated TCI-state specific to a ‘coresetPoolIndex’ value for certain channels that are triggered by a PDCCH on a CORESET that associated with the ‘coresetPoolIndex’ value. In these aspects, the channels include: a PUCCH transmission carrying HARQ-ACK information, if a ‘joint HARQ-ACK’ codepoint mode is configured for mTRP; an aperiodic CSI-RS resource set; and an aperiodic SRS Resource Set used for Beam Management and Antenna Switching.

In some designs, when two SRS resource sets for CB/NCB PUSCH are configured for the mDCI-based mTRP, a fixed rule may be specified as follows. The TCI state specific to a coresetPoolIndex value ‘0’ can be applied to the first SRS resource set. The TCI state specific to a coresetPoolIndex value ‘1’ can be applied for the second SRS resource set. The first SRS resource set can refer to the set with the lower set ID.

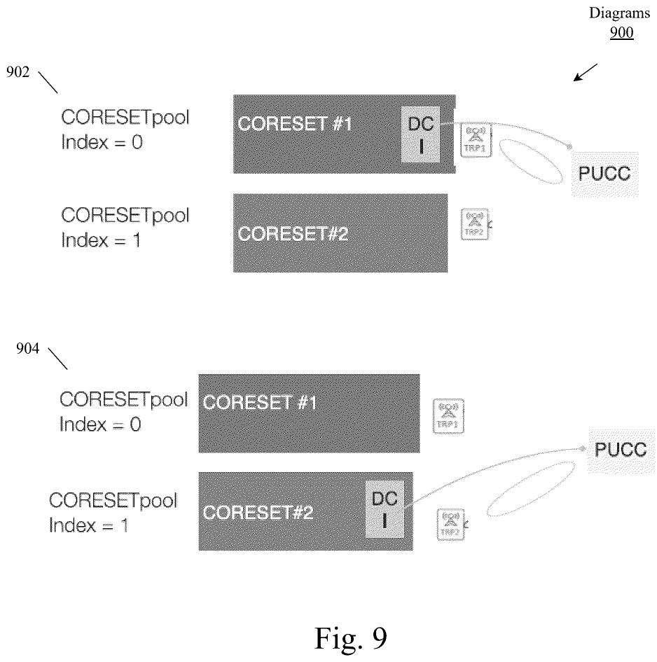

FIG. 9 shows diagrams 900 demonstrating a dynamic TCI-state selection for a given PUCCH resource according to various exemplary embodiments. In this example, it is assumed that the TCI-state #1 is associated with ‘coresetPoolIndex’=0 and TCI-state #2 is associated with ‘coresetPoolIndex’=1, as shown in the example of 902 and the example of 904.

In 902, the triggering DCI is detected in a CORESET with ‘coresetPoolIndex’=0. Thus, the corresponding PUCCH resource uses the ‘TCI-State #1’ corresponding to ‘coresetPoolIndex’=0. In 904, the triggering DCI is detected in a CORESET with ‘coresetPoolIndex’=1. Thus, the corresponding PUCCH resource uses the ‘TCI-State #2’ corresponding to ‘coresetPoolIndex’=1.

### EXAMPLES

In a first example, a method performed by a user equipment (UE), comprising establishing a connection to a base station in multi-transmission reception point (mTRP) mode, wherein the UE is configured to apply a first set of transmission configuration indicator (TCI) states to communicate with the base station via one or multiple TRPs, the UE is further configured that a TCI selection field is not present in a TCI state update command, receiving the TCI state update command indicating a TCI codepoint mapping to one or more downlink (DL) TCI states in a second set of TCI states, applying the one or more TCI states of the second set for physical downlink shared channel (PDSCH) receptions from one or multiple TRPs that is scheduled by the Downlink Control Information (DCI) that includes TCI state update command.

In a second example, the method of the first example, further comprising receiving a medium access control (MAC) control element (MAC-CE) for TCI state activation, the MAC-CE activating multiple TCI states and associating each one of multiple TCI codepoints to a respective one or more of the multiple TCI states, wherein the TCI state update command indicates the TCI codepoint of the multiple TCI codepoints associated with the second set of TCI states.

In a third example, the method of the second example, wherein the MAC-CE associates a first DL TCI state to a first codepoint of the TCI state update command, a second DL TCI state to a second TCI codepoint of the TCI state update command, and both the first and second DL TCI states to a third codepoint of the TCI state update command both the first and second DL TCI states to a third TCI codepoint.

In a fourth example, the method of the second example, wherein the TCI state update command comprises a downlink control information (DCI) format 1_1 or 1_2.

In a fifth example, one or more processors configured to perform any of the methods of the first through fourth examples.

In a sixth example, a user equipment (UE) comprising a transceiver configured to communicate with a network and a processor communicatively coupled to the transceiver and configured to perform any of the methods of the first through fourth examples.

In a seventh example, a method performed by a user equipment (UE) comprising establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, receiving a downlink control information (DCI) 1_0 or 0_0 scheduling a physical downlink shared channel (PDSCH) or a physical uplink shared channel (PUSCH), determining one or more TCI states of the first set of TCI states to apply for the PDSCH or the PUSCH scheduled by the DCI 1_0 or 0_0 and applying the one or more TCI states of the first set based on the determining.

In an eighth example, the method of the seventh example, further comprising receiving an explicit radio resource control (RRC) configuration indicating whether the first joint or DL TCI state, the second joint or DL TCI state, or both the first and second joint or DL TCI states shall apply to the PDSCH reception or PUSCH transmission.

In a ninth example, the method of the seventh example, further comprising receiving a configuration for a single frequency network (SFN) scheme or a coherent joint transmission (CJT) scheme for the PDSCH, wherein the UE supports two TCI states for CJT PDSCH receptions and applying both the first and second joint or DL TCI states to the PDSCH reception or the PUSCH transmission based on a hard-encoded rule in specification.

In a tenth example, the method of the seventh example, further comprising receiving a configuration for a PDSCH or PUSCH scheme other than a single frequency network (SFN) scheme or a coherent joint transmission (CJT) scheme for the PDSCH wherein the UE supports two TCI states for CJT PDSCH receptions and applying either the first or second joint or DL TCI state to the PDSCH reception or the PUSCH transmission based on a hard-encoded rule in specification.

In an eleventh example, one or more processors configured to perform any of the methods of the seventh through tenth examples.

In a twelfth example, a user equipment (UE) comprising a transceiver configured to communicate with a network and a processor communicatively coupled to the transceiver and configured to perform any of the methods of the seventh through tenth examples.

In a thirteenth example, a method performed by a user equipment (UE) comprising establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, the UE is further configured that a TCI selection field is present in a TCI state update command, receiving the TCI state update command indicating the TCI selection field and based on the TCI selection field, applying the first joint or DL TCI state for physical downlink shared channel (PDSCH) receptions from a first or second TRP and applying the second joint or DL TCI state for PDSCH receptions from the other of the first or second TRP that is scheduled by the Downlink Control Information (DCI) that includes TCI state update command.

In a fourteenth example, the method of the thirteenth example, wherein, when the TCI selection field indicates a first value, the first joint or DL TCI state is applied for PDSCH receptions from the first TRP and the second joint or DL TCI state is applied for PDSCH receptions from the second TRP.

In a fifteenth example, the method of the fourteenth example, wherein the first value is ‘10’.

In a sixteenth example, the method of the fourteenth example, wherein, when the TCI selection field indicates a second value, the first joint or DL TCI state is applied for PDSCH receptions from the second TRP and the second joint or DL TCI state is applied for PDSCH receptions from the first TRP.

In a seventeenth example, the method of the sixteenth example, wherein the second value is ‘11’.

In an eighteenth example, one or more processors configured to perform any of the methods of the thirteenth through seventeenth examples.

In a nineteenth example, a user equipment (UE) comprising a transceiver configured to communicate with a network and a processor communicatively coupled to the transceiver and configured to perform any of the methods of the thirteenth through seventeenth examples.

In a twentieth example, a method performed by a user equipment (UE) comprising establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs, receiving a configuration for aperiodic channel state information (CSI) reference signal (CSI-RS) resources for a first TRP and a second TRP and determining whether to apply the first joint or DL TCI state, the second joint or DL TCI state, or both the first and second joint or DL TCI state to the CSI-RS resources.

In a twenty first example, the method of the twentieth example, wherein, if the CSI-RS resources are configured with group-based beam reporting, the first joint or DL TCI state is applied for a first CSI-RS resource set and the second joint or DL TCI state is applied for a second CSI-RS resource set.

In a twenty second example, the method of the twenty first example, wherein the first CSI-RS resource set is configured by ‘resourcesForChannel’ and the second CSI-RS resource set is configured by ‘resourcesForChannel2’.

In a twenty third example, the method of the twentieth example, wherein, if the CSI-RS resources are configured as pairs of CSI-RS resources in a single CSI-RS resource set for non-coherent joint transmission (NCJT) operation, the first joint or DL TCI state is applied for a first pair of CSI-RS resources and the second joint or DL TCI state is applied for a second pair of CSI-RS resources.

In a twenty fourth example, the method of the twenty third example, wherein the first pair of CSI-RS resources is configured by ‘pair1OfNZP-CSI-RS’ and the second pair of CSI-RS resources is configured by ‘pair2OfNZP-CSI-RS’.

In a twenty fifth example, the method of the twentieth example, further comprising receiving a radio resource control (RRC) configuration indicating which of the first or second joint or DL TCI state is applied for a CSI-RS resource set.

In a twenty sixth example, the method of the twentieth example, wherein the RRC configuration is included in a CSI-AssociatedReportConfigInfo.

In a twenty seventh example, one or more processors configured to perform any of the methods of the twentieth through twenty sixth examples.

In a twenty eighth example, a user equipment (UE) comprising a transceiver configured to communicate with a network and a processor communicatively coupled to the transceiver and configured to perform any of the methods of the twentieth through twenty sixth examples.

In a twenty ninth example, a method performed by a user equipment (UE) comprising establishing a connection to a base station in multi-transmission reception point (mTRP) mode, wherein the UE is configured to apply a first set of transmission configuration indicator (TCI) states including a first joint or UL TCI state to communicate with the base station via one or multiple TRPs, receiving a sounding reference signal (SRS) resource set by applying the first joint or UL TCI state, receiving a TCI state update command indicating a second joint or UL TCI state for receiving a physical uplink shared channel (PUSCH) associated with the SRS resource set and deferring applying the second joint or UL TCI state until a next occasion of the SRS resource set after the PUSCH.

In a thirtieth example, the method of the twenty ninth example, further comprising receiving the PUSCH by applying the first joint or UL TCI state.

In a thirty first example, one or more processors configured to perform any of the methods of the twenty ninth through thirtieth examples.

In a thirty second example, a user equipment (UE) comprising a transceiver configured to communicate with a network and a processor communicatively coupled to the transceiver and configured to perform any of the methods of the twenty ninth through thirtieth examples.

In a thirty third example, a method performed by a user equipment (UE) comprising establishing a connection to a base station in multi-downlink control information (mDCI) based multi-transmission reception point (mTRP) mode, wherein the UE is configured with a physical uplink control channel (PUCCH) transmission carrying HARQ-ACK information, an aperiodic channel state information reference signal (CSI-RS) resource set, or a sounding reference signal (SRS) resource set for physical uplink shared channel (PUSCH) transmissions, receiving a DCI in a first control resource set (CORESET) triggering one of the two SRS resource sets and determining a first transmission configuration indication (TCI) state to apply for the configured PUCCH transmission, aperiodic CSI-RS resource set, or SRS resource set based on a first CORESET pool index for the first CORESET.

In a thirty fourth example, the method of the thirty third example, wherein the first TCI state is associated with the first CORESET pool index.

In a thirty fifth example, the method of the thirty fourth example, wherein a second TCI state is associated with a second CORESET pool index, the second TCI state being applied when a DCI is received in a second CORESET configured with the second CORESET pool index.

In a thirty sixth example, the method of the thirty third example, wherein the UE is configured with two SRS resource sets for PUSCH transmissions, wherein the TCI state to apply for each of the two SRS resource sets is based on a hard-encoded rule.

In a thirty seventh example, the method of the thirty sixth example, wherein the two SRS resource sets are determined as a first SRS resource set having a lower set ID and a second SRS resource set, wherein respective TCI states are associated with the respective first and second SRS resource sets.

In a thirty eighth example, one or more processors configured to perform any of the methods of the thirty third through thirty seventh examples.

In a thirty ninth example, a user equipment (UE) comprising a transceiver configured to communicate with a network and a processor communicatively coupled to the transceiver and configured to perform any of the methods of the thirty third through thirty seventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
establishing a connection to a base station in multi-transmission reception point (mTRP) mode, wherein the UE is configured to apply a first set of transmission configuration indicator (TCI) states to communicate with the base station via one or multiple TRPs, the UE is further configured that a TCI selection field is not present in a TCI state update command;
receiving the TCI state update command indicating a TCI codepoint mapping to one or more downlink (DL) TCI states in a second set of TCI states;
applying the one or more TCI states of the second set for physical downlink shared channel (PDSCH) receptions from one or multiple TRPs that is scheduled by the Downlink Control Information (DCI) that includes TCI state update command.

2. The processor of claim 1, wherein the operations further comprise:
receiving a medium access control (MAC) control element (MAC-CE) for TCI state activation, the MAC-CE activating multiple TCI states and associating each one of multiple TCI codepoints to a respective one or more of the multiple TCI states,
wherein the TCI state update command indicates the TCI codepoint of the multiple TCI codepoints associated with the second set of TCI states.

3. The processor of claim 2, wherein the MAC-CE associates a first DL TCI state to a first codepoint of the TCI state update command, a second DL TCI state to a second TCI codepoint of the TCI state update command, and both the first and second DL TCI states to a third codepoint of the TCI state update command both the first and second DL TCI states to a third TCI codepoint.

4. The processor of claim 2, wherein the TCI state update command comprises a downlink control information (DCI) format 1_1 or 1_2.

5. A processor of a user equipment (UE) configured to perform operations comprising:
establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs;
receiving a downlink control information (DCI) 1_0 or 0_0 scheduling a physical downlink shared channel (PDSCH) or a physical uplink shared channel (PUSCH) ;
determining one or more TCI states of the first set of TCI states to apply for the PDSCH or the PUSCH scheduled by the DCI 1_0 or 0_0; and
applying the one or more TCI states of the first set based on the determining.

6. The processor of claim 5, wherein the operations further comprise:
receiving an explicit radio resource control (RRC) configuration indicating whether the first joint or DL TCI state, the second joint or DL TCI state, or both the first and second joint or DL TCI states shall apply to the PDSCH reception or PUSCH transmission.

7. The processor of claim 5, wherein the operations further comprise:
receiving a configuration for a single frequency network (SFN) scheme or a coherent joint transmission (CJT) scheme for the PDSCH, wherein the UE supports two TCI states for CJT PDSCH receptions; and
applying both the first and second joint or DL TCI states to the PDSCH reception or the PUSCH transmission based on a hard-encoded rule in specification.

8. The processor of claim 5, wherein the operations further comprise:
receiving a configuration for a PDSCH or PUSCH scheme other than a single frequency network (SFN) scheme or a coherent joint transmission (CJT) scheme for the PDSCH wherein the UE supports two TCI states for CJT PDSCH receptions; and
applying either the first or second joint or DL TCI state to the PDSCH reception or the PUSCH transmission based on a hard-encoded rule in specification.

9. A processor of a user equipment (UE) configured to perform operations comprising:
establishing a connection to a base station in multi-transmission reception point (mTRP) mode, wherein the UE is configured to apply a first set of transmission configuration indicator (TCI) states including a first joint or DL TCI state and a second joint or DL TCI state to communicate with the base station via one or multiple TRPs;
receiving a configuration for aperiodic channel state information (CSI) reference signal (CSI-RS) resources for a first TRP and a second TRP; and
determining whether to apply the first joint or DL TCI state, the second joint or DL TCI state, or both the first and second joint or DL TCI state to the CSI-RS resources.

10. The processor of claim 9, wherein, if the CSI-RS resources are configured with group-based beam reporting, the first joint or DL TCI state is applied for a first CSI-RS resource set and the second joint or DL TCI state is applied for a second CSI-RS resource set.

11. The processor of claim 10, wherein the first CSI-RS resource set is configured by ‘resourcesForChannel’ and the second CSI-RS resource set is configured by ‘resourcesForChannel2’.

12. The processor of claim 9, wherein, if the CSI-RS resources are configured as pairs of CSI-RS resources in a single CSI-RS resource set for non-coherent joint transmission (NCJT) operation, the first joint or DL TCI state is applied for a first pair of CSI-RS resources and the second joint or DL TCI state is applied for a second pair of CSI-RS resources.

13. The processor of claim 12, wherein the first pair of CSI-RS resources is configured by ‘pair1OfNZP-CSI-RS’ and the second pair of CSI-RS resources is configured by ‘pair2OfNZP-CSI-RS’.

14. The processor of claim 9, wherein the operations further comprise:
receiving a radio resource control (RRC) configuration indicating which of the first or second joint or DL TCI state is applied for a CSI-RS resource set.

15. The processor of claim 9, wherein the RRC configuration is included in a CSI-AssociatedReportConfigInfo.
